(19) United States
(12) Patent Application Publication
(10) Pub. No.: US 2025/0362964 A1
(43) Pub. Date: Nov. 27, 2025

(54) TRACKING RESOURCE INGESTION

(71) Applicant: Wells Fargo Bank, N.A., San Francisco, CA (US)

(72) Inventors: Kimberly Patricia Baker, Fort Mill, SC (US); John J. Banfield, Queen Creek, AZ (US); Genevive D. Castro, Roseville, CA (US); Nayana Devanandan, San jose, CA (US); Gregory Thomas Duvall, Garland, TX (US); Prithiviraj Gurumoorthi, Tegacay, SC (US); Oluwadamilola A. Isijola, Rockwall, TX (US); Peter W. Kaprielian, Concord, CA (US); David LY Nguyen, Irvine, CA (US); Brian Michael Pawlik, Mesa, AZ (US); Chandrasekar Ramasamy, Hillsborough, NJ (US); Neha Singhal, Melissa, TX (US); Sydia A. Taylor-Wint, Huntersville, NC (US); Dena L. Woolley, Queen Creek, AZ (US)

(21) Appl. No.: 18/673,668

(22) Filed: May 24, 2024

(51) Int. Cl. G06F 9/50

(52) U.S. Cl. CPC G06F 9/5033

(57) ABSTRACT

System and techniques to track the ingestion of resources described herein. A device can receive a connection from a reporting entity at an intake interface of the device. A set of data that includes a representation of a resource involved in a transaction can be received over the connection. This received data can be mapped via an intake interface into fields of a template. Based on a first field of the template, a connection to an external service can be made to retrieve a value to complete a second field of the template. A ruled engine can be applied to modify the first field of the template or the second field of the template to create a compliant template that can be aggregated with other compliant templates to produce a report of a class of transactions that includes the transaction.

### TECHNICAL FIELD

Embodiments described herein generally relate to control systems of devices handling physical resource and more specifically to tracking resource ingestion.

### BACKGROUND

Physical resource control systems are often integrated frameworks designed to manage the intake, processing, or distribution of materials. Physical resource control systems generally use sensors, scanners, or software to efficiently monitor or allocate resources. Such systems can be used in sectors such as agriculture, manufacturing, or retail, to automate tasks for improved operational efficiency or throughput. Often, the physical resources being handled have additional constraints on operation, such as social constraints (e.g., laws, regulations, etc.). Physical resource control systems often include additional technical measures to ensure compliance with these additional constraints while provided the aforementioned improved operational efficiency.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for tracking resource ingestion, according to an embodiment.

FIG. 2 illustrates an example of a system for tracking tender ingestion, according to an embodiment.

FIG. 3 illustrates a flow diagram of an example of a method for tracking resource ingestion, according to an embodiment.

FIG. 4 is a block diagram illustrating an example of a machine upon which one or more embodiments may be implemented.

### DETAILED DESCRIPTION

Accurate reporting or data collection with regard to devices such as deposit terminals is important for ensuring reliability and efficiency of transactions involving physical resources like recyclable materials and donated goods. Effective reporting enables effective resource management and operational planning by, for example, assessing input or output levels. Depending on the physical resources being collected, reporting can also be important for regulatory compliance or auditing purposes. Recyclables, donations, etc., are often subject to regulatory standards that require stringent record-keeping and reporting. Thus, tracking what is deposited can fundamentally affect how resources are ingested by a system.

An issue can arise when, for example, different channels of ingress for a resource exist. Often, such channels arise over time, such as a bin donation for clothing being added to a system after a manual donation process in which donations were logged by people into a database, for example. Often, as new vectors of ingress are added, including different types of deposit terminals, different ways in which ingestion data can enter the system arise. For example, if a first terminal reports on volume or weight of deposited materials and a second terminal provides a listing of clothing deposited (e.g., by scanning a tag of a garment), the reports from these terminals will be different. Integrating all of these disparate reporting sources can lead to challenging engineer problems that are difficult, expensive (e.g., in power, processing time, latency, etc.) and fragile. Reporting for regulatory compliance adds complexity and difficulty to this already complex system.

To address this issue, organizations can provide a translation layer between the various ingestion terminals and the reporting apparatus of the system. This translation layer provides an application programming interface (API) that accepts data from a reporting entity (e.g., a deposit terminal) about a physical resource. The API populates a reporting template (e.g., schema defined data structures) with the data in accordance with the schema to, for example, validate the accuracy of the data, or other metrics of correctness (e.g., a correct data type, within an acceptable range of values, etc.). The system can also employ a rules engine to manipulate template fields, such as by converting numbers (e.g., from natural to real numbers, rounding, etc.), translating text (e.g., from one language to another), or switching positions of fields (e.g., correcting transposed address lines).

In an example, the rules engine can also provide validation for a data field. In practice, this arrangement enables non-engineering personal to enact the validation rules to ensure regulatory compliance without modifying the underlying technical infrastructure of the system. This is often important for adoption of the system in practical use because of the import of such compliance as well as the changing nature of what it means to be compliant. Additional details and examples are provided below.

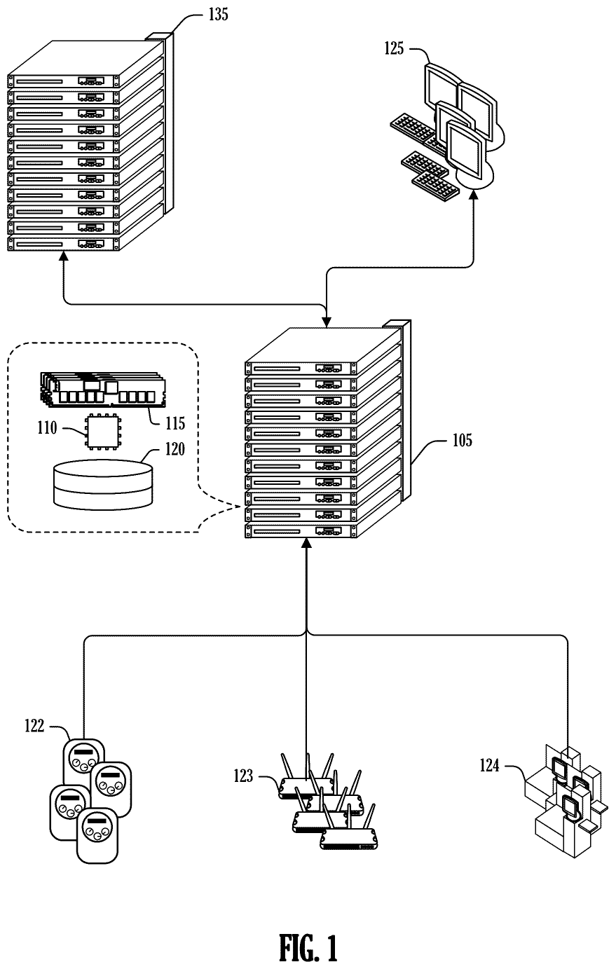

FIG. 1 is a block diagram of an example of an environment including a system 105 for tracking resource ingestion, according to an embodiment. The system 105 includes processing circuitry 110, storage 120 (e.g., power-stable storage such as a hard drive, solid state drive, etc.), and memory 115. The memory 115 is generally used to maintain running state information for the system 105 that is generally discarded between system power cycles or restarts. The memory 115 and the storage 120 are both forms of computer readable media. The processing circuitry 110 or software residing in the memory 115 or storage 120 executing on the processing circuitry 110 configure the system 105 to perform various operations when in operation.

The system 105 is communicatively coupled (e.g., networked) when in operation to reporting entities, such as utility meters 122, network endpoints 123, or transaction terminals 124. These reporting entities all accept some resource (e.g., natural gas for the utility meters 122, bandwidth for the network endpoints 123, or notes deposited at the transaction terminals 124), the ingestion of which will be tracked by the system 105. The system is also communicatively coupled, when in operation, to a report consumer 125 that uses (e.g., acts on) final resource ingestion tracking deliverables. Similar to the system 105, the report consumer 125 and the reporting entities include computer hardware (e.g., processing circuitry, memory, etc.) to interface with the system 105.

To implement tracking of resource ingestion, the processing circuitry 110 is configured to receive a connection from a reporting entity (e.g., the network endpoints 123) at an intake interface. Here, the intake interface can include a physical interface, such as a network port, serial port, etc., a software interface, such as an application programming interface (API), or a combination of software and hardware. In an example, there are multiple intake interfaces. In an example, an intake interface from the multiple intake interface is specific to a type or class of reporting entity. For example, a network interface and API can be specific to the utility meters 122 and a different physical interface (e.g., a serial interface) and API can be specific to the transaction terminals 124. In an example, the interface is the same for all reporting entities. This arrangement can help with some complexity issues that can arise from different reporting entities by providing a common standard by which all reporting entities can be designed to implement.

The API can be implemented in a variety of models, such as Representational State Transfer (REST). REST uses standard Hypertext Transfer Protocol (HTTP) methods such as GET, POST, PUT, and DELETE for communication. REST APIs are stateless and separate the concerns of client and server. Simple Object Access Protocol (SOAP) is another example of API implementation. unlike REST, SOAP is a protocol and uses extensible Markup Language (XML) to define the message format and to set the rules for translating application and platform-specific data into a standardized communication format. SOAP can operate over HTTP, Simple Mail Transfer Protocol (SMTP), Transmission Control Protocol (TCP), and more. WebSocket is another example API implementation. WebSocket provides full-duplex communication channels over a single TCP connection. gRPC Remote Procedure Calls (gRPC) is another example API implementation. gRPC uses HTTP/2 for transport and Protocol Buffers as an interface description language. Open Data Protocol (OData) is another example API implementation. OData is an open protocol that enables a simplified creation and consumption of queryable and interoperable RESTful APIs. OData is often used to expose and access information from a variety of sources, including relational databases, file systems, content management systems, or traditional web sites. JavaScript Object Notation Remote Procedure Call (JSON-RPC) and XML-RPC are other examples of API implementations. These protocols enable for remote procedure calls using JSON and XML respectively. They define a simple and flexible way to send messages between clients and servers, generally facilitating actions rather than data transfer.

The processing circuitry 110 is configured to receive a set of data over the connection. This set of data includes a representation of a resource involved in a transaction. For example, the data can list a volume of water received at a utility meter, a number of bills received at a transaction terminal, a total amount, in value, of notes received at a transaction terminal, a weight of clothing deposited in a donation bin, etc.

In an example, where the intake interface includes an API, the API is configured to invoke a validation service to verify that the set of data complies with a validation standard or a template. Here, the API includes instructions beyond simply handling the intake of the data and causes the processing circuitry 110 to also validate the data against a predefined standard. For the validation standard, the predefined standard can be included in the instructions themselves, read from a database, from a configuration file, or other location that the instructions specify. For a template, the validation standard can be included in the template, such that execution of the template or reading data contained in the template provides the validation standard.

In an example, to verify that the set of data complies with the validation standard or template, the processing circuitry 110 is configured to determine that data in the set of data does not comply with the validation standard and writing a failure record to a failure field of the template. Here, the template includes fields dedicated to failures (e.g., errors) of validation. Thus, the template can still retain the data provided by the reporting entity and also include an indication that the data does not comply with the validation standard. This can be helpful to enable operation, or reporting, on the data while still providing an opportunity to notify the reporting entity of the failure and correct the data for future transmissions. Thus, in an example, the data in the set of data that does not comply with the validation standard is written to a field of a template for the transaction. In an example, the data in the set of data that does not comply with the validation standard is discarded. This last example addresses situations in which invalid data is not useful to downstream processing. Thus, the data is discarded, which can lead to more efficient messaging (e.g., transporting the template without bad data leads to smaller transmissions) and also avoids inadvertently including bad data in downstream calculations or reports.

The processing circuitry 110 is configured to map the set of data into fields of the template. In an example, the mapping is performed by the intake interface. The mapping enables different reporting entities to provide the set of data in a variety of formats (e.g., data types, field names, etc.) that the mapping will translate into the template fields. In an example, the mapping is intrinsic to the instructions run from the processing circuitry 110, or such an intrinsic component provides instructions where to locate the mapping (e.g., in a configuration file, database, startup parameter, etc.). In an example, fields of the template are based on a set of directives (e.g., routines, instructions, commands, etc.) received from a third party. In an example, the set of directives are regulations promulgated for reporting on the class of transactions. In an example, the third party is a government entity. These last two examples provide a mechanism by which a regulatory body, such as a government, can promulgate mapping, or validation, instructions that can be readily integrated into the system 105. In a variety of contexts, this ability permits conformance with policies, laws, or other institutional restrictions on the operation of the system 105 without requiring additional engineering resources to implement these restrictions.

In an example, fields of the template are serialized for transport. In an example, a serialized form of the fields of the template conforms to a JavaScript Object Notation (JSON) family of standards. Other types of serialization can be used, such as comma or tab delimited data structures, computer language specific serialization protocols, etc.

The processing circuitry 110 is configured to connect, based on a first field of the template being set, to an external service 135 (e.g., external resource) to retrieve a value to complete a second field of the template. For example, if the first field indicates a location of an automatic teller machine, the external service 135 can include additional information about the location. Similarly, if the first field identifies a person, then the external service 135 can provide biographic information on the person. Accordingly, in an example, the external service 135 provides information on a user that initiated the transaction. In an example, the information is demographic or biographic.

The external service 135 can take a variety of forms. For example, the external service 135 can be a programmatic interface to execute instructions to retrieve the requested information when asked. Examples can include interfacing with a government database, initiating a count of available spaces in a warehouse, etc. In a sense, this arrangement results in a type of real-time data acquisition by the external service 135 on behalf of the system 105. In an example, the external service 135 is a database populated by a batch process from additional external services. In this example, data can be delivered in large chunks, ahead of time, and curated by the external service 135. This can be an efficient and convenient way to manage information ancillary to that provided by the reporting entities that nevertheless can be useful in downstream activities.

The processing circuitry 110 is configured to apply a rules engine to modify the first field of the template or the second field of the template to create a compliant template. It was mentioned above that aspects of data mapping or validation with respect to the template can be provided by a third party. The rules engine provides another formalized mechanism by which restrictions on the operation of the system 105 can be imposed (e.g., established, changed, removed, etc.) without requiring a change to the underlying aspects of the system 105. Accordingly, the rules engine is configured to accept rules—for example crafted and delivered by regulators, business analysts, etc.—to modify fields of the template without additional technical modifications to the system 105. In an example, applying the rules engine to modify the first field of the template or the second field of the template to create the compliant template includes rewriting the first field based on a rule of the rules engine. For example, if the value in the first field is a real number out to three decimals places, and the rule can rewrite the value to be a nearest integer. Other types of rewriting can include translating from one language to another, removing a middle name for an individual, or converting from a first measurement system to a second measurement system. In an example, applying the rules engine to modify the first field of the template or the second field of the template to create the compliant template includes swapping a first value in the first field with a second value in the second field. In this last example, the first value may provide a key that is used to retrieve additional data from the external service 135. However, the retrieved data is more appropriate to include in the first field. Consider a user entering a unique number to identify themselves. The unique number is entered into the first field. The unique number is used by the system 105 to retrieve a name for the person from the external service 135. Then, the name is used to populate the first field.

In an example, the processing circuitry 110 can be configured to provide a user interface that is configured to construct a rule for the rules engine. Here, the user interface provides a user with the available commands (e.g., translations, rounding, field exchanging, etc.), available data (e.g., in fields of the template, from the external service 135, etc.) and a technique to connect one or more commands or data to construct a rule. In an example, the user interface is configured to install the rule in the rules engine to be applied to a next template. Thus, the user interface provides the portal through which additional restrictions to the operation of the system 105 can be installed, changed, or removed from the system 105.

The processing circuitry 110 is configured to aggregate the compliant template with other compliant templates to produce a report of a class of transactions that includes the transaction. The aggregation of compliant templates based on transaction class illustrates the tracking of the resource ingestion handled by the system 105 for a variety of reporting entities. Consider cash deposits for an individual. Often, there are government concerns with cash use for illegal activities. These concerns often are addressed by the tracking of cash transactions made by individuals or companies. Thus, ingestion of notes can represent a physical resource that can be tracked with the system 105. Similarly, ingestion of water resources to fill a reservoir are aggregated to enable control over the aggregate in-flow of water to the reservoir. In an example, the class of transactions includes at least one of accelerator utilization, memory utilization, storage utilization, or deposited notes.

As noted above, in an example, the reporting entity is one of multiple reporting entities that connect to the intake interface for the class of transactions. In an example, a first subset of the multiple reporting entities belongs to a first category and a second subset of the multiple reporting entities belongs to a second category. Here, deposited notes can be deposited at an automatic teller machine, a teller window, or via an exchange. Each of these represent categories (e.g., different types) of the multiple reporting entities for a single class of transactions. In an example, membership in the first category and the second category is mutually exclusive.

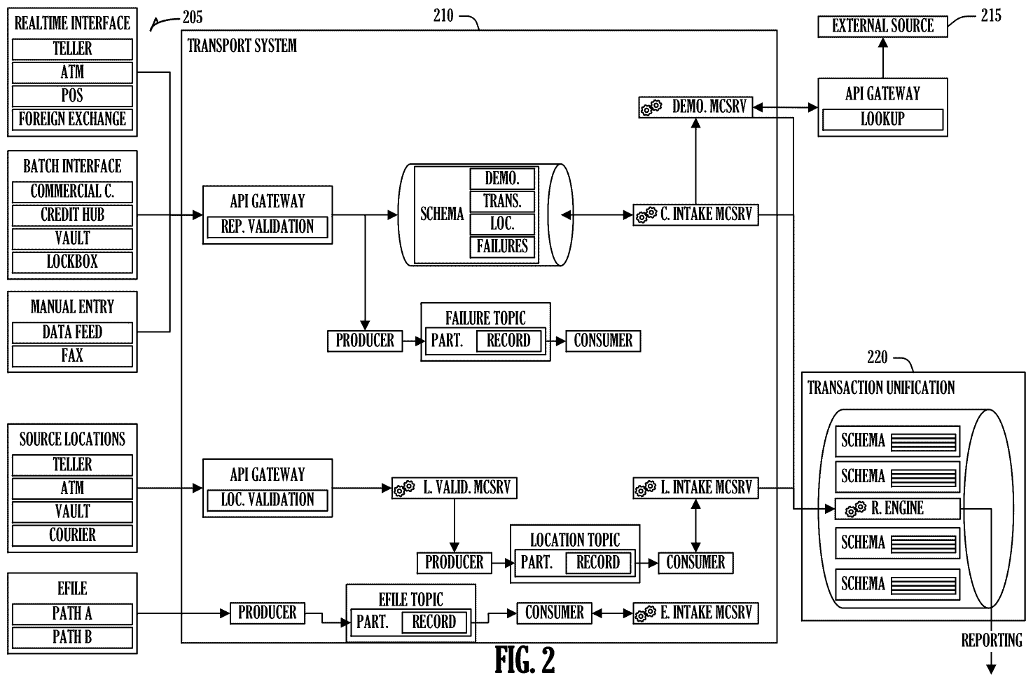

FIG. 2 illustrates an example of a system 210 for tracking tender ingestion, according to an embodiment. The system 210 tracks the ingestion of notes at a variety of reporting entities 205, sometimes called Currency Transaction Report (CTR) reporting. For large institutions, transaction counts can be quite high. For example, tellers (e.g., human or machine services at a physical location) can provide 85% of note transactions for CTR reporting. Data for these transactions can be received through several different data flows, each with several additional queries or transformations. Given millions of CTR relevant transaction each day, the total processing can be quite large.

When the number and types of reporting entities 205 grow, the complexity of CTR operations can also grow. To address these issues, the system 210 implements several techniques. For example, Data received from an upstream channel (e.g., from the reporting entities 205) is placed into a standard format through a single path. This is achieved by the system 210 via the API gateway. The system 210 also performs data validation using validation rules (e.g., via the rules engine discussed above or at the API gateway). This approach leads to “Straight line” operational processing of transactions, reducing overall data handling and eliminating of matching transactions except for adjustments, which can be handled by the transaction unification component 220. The rules engine also enables configurable rules to be uniformly applied to incoming transactions. All of this results in enhanced controls and monitoring to ensure data flows and handling are working as expected.

The API gateway can be configured to provide different interfaces depending upon the category of reporting entity involved. For example, a Realtime Transaction Interface can consume transactional data in a simplified operational format, enabling for straight through processing of data. This transactional data is received in real-time (e.g., as or immediately following the completion of a transaction). In an example, a Batch Transaction Interface can be used to consume large volumes of transactional data in a simplified operational format, enabling for straight through processing of data. Here, batch data means that several (often hundreds, thousands, or greater numbers) of transactions are accepted at once over the interface. In an example, a Manual Transaction Interface can consume entered transactional data in a simplified operational format. Data to be received directly from manual (e.g., entered by a person at a user interface) input.

The system 210 can make use of the external source 215 to retrieve demographic information (e.g., via a demographic microservice). In an example, the demographic information can be accessed in real-time (e.g., as a given transaction is being processed). In an example, the system 210 can include access to location information that is located in several different applications (e.g., another type for the external source 215). In an example, multiple interfaces can be used to bring location data from upstream applications into the system 210 via an automated, quasi-real-time technique that maintains location data with the system 210 or via batch techniques which will obtain location data daily.

The system 210 can include, or can be connected to, a rules engine. The rules engine is configured to incorporate demographic information, or to prepare the data for entry into a CTR System of Record (CREEP), which is not illustrated. The system 210 can include, or can be connected to, a deduplication engine. Due to the possibility of getting multiple transactions through different paths, the deduplication engine prevents overreporting of transactions when being aggregated. In an example, an automated image retrieval interface can be used to extract information from notes, such as checks.

In an example, a controls framework can be employed to lower risk due to high transactions volumes. The control framework can oversee a requirements repository to enable relationships between of business, user, system, functional, or non-functional requirements. In an example, the controls framework can be configured to implement a controls repository configured to relate requirements to controls and controls to code (e.g., instructions). This can enrich reporting or monitoring to ensure adherence to requirements by the operational environment. In an example, the controls framework is configured to implement a monitoring workflow to provide reporting on warning or critical operating issues. This reporting is configured to enable tracking of issues, alerts being generated and delivered, and recordation of issues and resolutions to those issues. In an example, the controls framework includes a dashboard UI to interface with the controls (e.g., rules), reporting, and data (e.g., recorded data, issues, resolutions, etc.).

In an example, the system 210 can include or be connected to a data fabrication component. Testing rule changes effectively is helped by a significant amount of test data. The data fabrication component is configured to create this data to address complex test scenarios to enable testers great control over test scenarios without using confidential data in the testing environments.

A large of volume of reports can be generated by CTR related applications. In an example, the system 210 includes or is connected to a reporting productivity component configured to accept data to create these reports. The reporting productivity component is configured to produce reports that include data to trend capacity or performance data to gauge the operational status of the system 210.

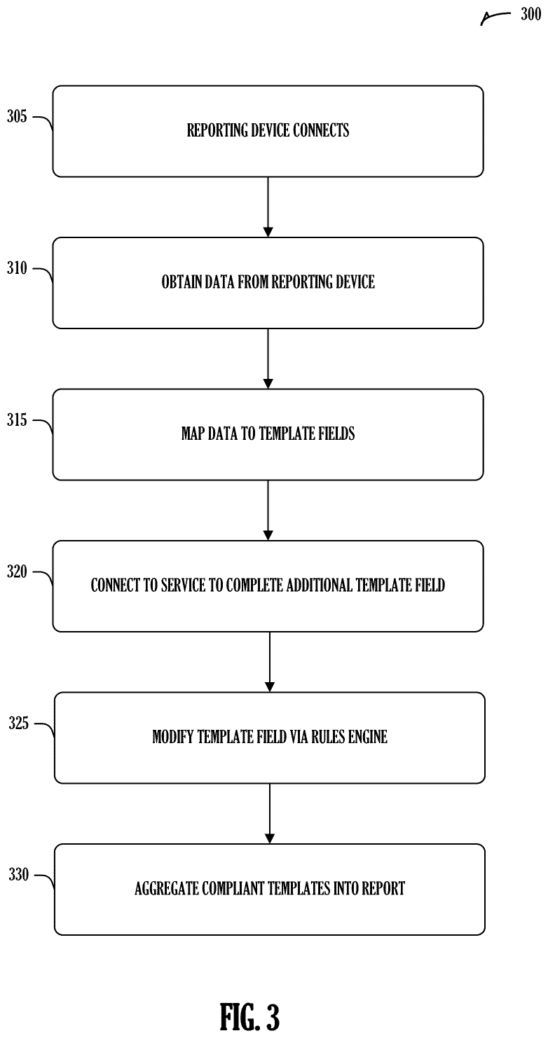

FIG. 3 illustrates a flow diagram of an example of a method 300 for tracking resource ingestion, according to an embodiment. The operations of the method 300 are performed by computer hardware, such as that described above or below (e.g., processing circuitry).

At operation 305, a connection from a reporting entity is received at an intake interface. In an example, the intake interface includes an application programming interface (API) to receive connections.

At operation 310, a set of data is received over the connection. In an example, the set of data includes a representation of a resource involved in a transaction. In an example, where the intake interface includes the API, the API invokes a validation service to verify that the set of data complies with a validation standard or a template. In an example, the method 300 includes determining that data in the set of data does not comply with the validation standard, and writing a failure record to a failure field of the template. In an example, the data in the set of data that does not comply with the validation standard is written to a field of a template for the transaction. In an example, the data in the set of data that does not comply with the validation standard is discarded.

At operation 315, the set of data is mapped into fields of a template. In an example, the mapping is performed by the intake interface. In an example, fields of the template are based on a set of directives received from a third party. In an example, the set of directives are regulations promulgated for reporting on the class of transactions. In an example, the third party is a government entity.

In an example, fields of the template are serialized for transport. In an example, a serialized form of the fields of the template conforms to a JavaScript Object Notation (JSON) family of standards.

At operation 320, connect, based on a first field of the template being set, to an external service to retrieve a value to complete a second field of the template. In an example, the external service provides information on a user that initiated the transaction. In an example, the information is demographic or biographic. In an example, the external service is a database populated by a batch process from additional external services.

At operation 325, a rules engine is applied to modify the first field of the template or the second field of the template to create a compliant template. In an example, applying the rules engine to modify the first field of the template or the second field of the template to create the compliant template includes rewriting the first field based on a rule of the rules engine. In an example, applying the rules engine to modify the first field of the template or the second field of the template to create the compliant template includes swapping a first value in the first field with a second value in the second field.

In an example, the operations of the method 300 can include providing a user interface. In an example, the user interface is configured to construct a rule for the rules engine. In an example, the user interface is configured to install the rule in the rules engine to be applied to a next template.

At operation 330, the compliant template is aggregated with other compliant templates to produce a report of a class of transactions that includes the transaction. In an example, the class of transactions includes at least one of accelerator utilization, memory utilization, storage utilization, or deposited notes. In an example, the reporting entity is one of multiple reporting entities that connect to the intake interface for the class of transactions. In an example, a first subset of the multiple reporting entities belongs to a first category and a second subset of the multiple reporting entities belongs to a second category. In an example, membership in the first category and the second category is mutually exclusive.

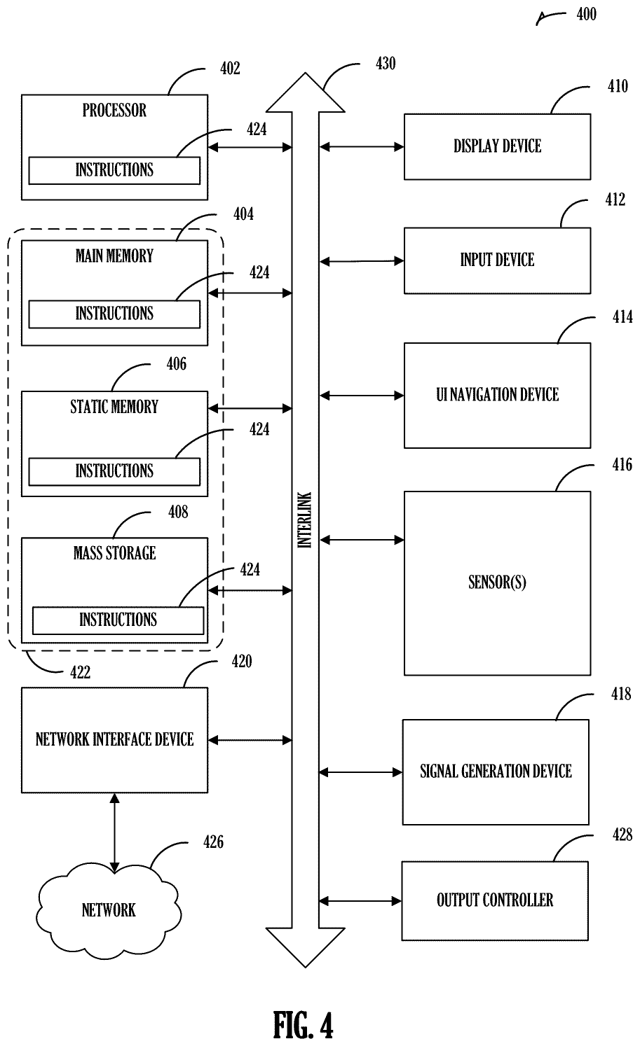

FIG. 4 illustrates a block diagram of an example machine 400 upon which any one or more of the techniques (e.g., methodologies) discussed herein may perform. Examples, as described herein, may include, or may operate by, logic or a number of components, or mechanisms in the machine 400. Circuitry (e.g., processing circuitry) is a collection of circuits implemented in tangible entities of the machine 400 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 400 follow.

In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 400 may include a hardware processor 402 (e.g., a central processing unit (CPU), a graphics processing unit (GPU), a hardware processor core, or any combination thereof), a main memory 404, a static memory (e.g., memory or storage for firmware, microcode, a basic-input-output (BIOS), unified extensible firmware interface (UEFI), etc.) 406, and mass storage 408 (e.g., hard drives, tape drives, flash storage, or other block devices) some or all of which may communicate with each other via an interlink (e.g., bus) 430. The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 408, a signal generation device 418 (e.g., a speaker), a network interface device 420, and one or more sensors 416, such as a global positioning system (GPS) sensor, compass, accelerometer, or other sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 402, the main memory 404, the static memory 406, or the mass storage 408 may be, or include, a machine readable medium 422 on which is stored one or more sets of data structures or instructions 424 (e.g., software) embodying or utilized by any one or more of the techniques or functions described herein. The instructions 424 may also reside, completely or at least partially, within any of registers of the processor 402, the main memory 404, the static memory 406, or the mass storage 408 during execution thereof by the machine 400. In an example, one or any combination of the hardware processor 402, the main memory 404, the static memory 406, or the mass storage 408 may constitute the machine readable media 422. While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 422 may be representative of the instructions 424, such as instructions 424 themselves or a format from which the instructions 424 may be derived. This format from which the instructions 424 may be derived may include source code, encoded instructions (e.g., in compressed or encrypted form), packaged instructions (e.g., split into multiple packages), or the like. The information representative of the instructions 424 in the machine readable medium 422 may be processed by processing circuitry into the instructions to implement any of the operations discussed herein. For example, deriving the instructions 424 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 424.

In an example, the derivation of the instructions 424 may include assembly, compilation, or interpretation of the information (e.g., by the processing circuitry) to create the instructions 424 from some intermediate or preprocessed format provided by the machine readable medium 422. The information, when provided in multiple parts, may be combined, unpacked, and modified to create the instructions 424. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 424 may be further transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 400, and includes digital or analog communications signals or other intangible medium to facilitate communication of such software. A transmission medium is a machine readable medium.

### ADDITIONAL NOTES & EXAMPLES

Example 1 is a device for tracking resource ingestion, the device comprising: a memory including instructions; and processing circuitry that, when in operation, is configured by the instructions to: receive a connection from a reporting entity at an intake interface; receive a set of data over the connection, the set of data including a representation of a resource involved in a transaction; map, via the intake interface, the set of data into fields of a template; connect, based on a first field of the template being set, to an external service to retrieve a value to complete a second field of the template; apply a rules engine to modify the first field of the template or the second field of the template to create a compliant template; and aggregate the compliant template with other compliant templates to produce a report of a class of transactions that includes the transaction.

In Example 2, the subject matter of Example 1, wherein fields of the template are based on a set of directives received from a third party.

In Example 3, the subject matter of Example 2, wherein the set of directives are regulations promulgated for reporting on the class of transactions.

In Example 4, the subject matter of Example 3, wherein the third party is a government entity.

In Example 5, the subject matter of any of Examples 2-4, wherein fields of the template are serialized for transport.

In Example 6, the subject matter of Example 5, wherein a serialized form of the fields of the template conforms to a JavaScript Object Notation (JSON) family of standards.

In Example 7, the subject matter of any of Examples 1-6, wherein the intake interface includes an application programming interface (API) to receive connections.

In Example 8, the subject matter of Example 7, wherein the API invokes a validation service to verify that the set of data complies with a validation standard or the template.

In Example 9, the subject matter of Example 8, wherein the processing circuitry is configured by the instructions to: determine that data in the set of data does not comply with the validation standard; and write a failure record to a failure field of the template.

In Example 10, the subject matter of Example 9, wherein the data in the set of data that does not comply with the validation standard is written to a third field.

In Example 11, the subject matter of any of Examples 9-10, wherein the data in the set of data that does not comply with the validation standard is discarded.

In Example 12, the subject matter of any of Examples 1-11, wherein the external service provides information on a user that initiated the transaction.

In Example 13, the subject matter of Example 12, wherein the information is demographic or biographic.

In Example 14, the subject matter of any of Examples 1-13, wherein the class of transactions includes at least one of accelerator utilization, memory utilization, storage utilization, or deposited notes.

In Example 15, the subject matter of Example 14, wherein the reporting entity is one of multiple reporting entities that connect to the intake interface for the class of transactions.

In Example 16, the subject matter of Example 15, wherein a first subset of the multiple reporting entities belongs to a first category, a second subset of the multiple reporting entities belongs to a second category, and wherein membership in the first category and the second category is mutually exclusive.

In Example 17, the subject matter of any of Examples 1-16, wherein, to apply the rules engine to modify the first field of the template or the second field of the template to create the compliant template, the processing circuitry is configured to rewrite the first field based on a rule of the rules engine.

In Example 18, the subject matter of any of Examples 1-17, wherein, to apply the rules engine to modify the first field of the template or the second field of the template to create the compliant template, the processing circuitry is configured to swap a first value in the first field with a second value in the second field.

In Example 19, the subject matter of any of Examples 1-18, wherein the processing circuitry is configured by the instructions to provide a user interface configured to: construct a rule for the rules engine; and install the rule in the rules engine to be applied to a next template.

In Example 20, the subject matter of any of Examples 1-19, wherein the external service is a database populated by a batch process from additional external services.

Example 21 is a method for tracking resource ingestion, the method comprising: receiving a connection from a reporting entity at an intake interface; receiving a set of data over the connection, the set of data including a representation of a resource involved in a transaction; mapping, via the intake interface, the set of data into fields of a template; connecting, based on a first field of the template being set, to an external service to retrieve a value to complete a second field of the template; applying a rules engine to modify the first field of the template or the second field of the template to create a compliant template; and aggregating the compliant template with other compliant templates to produce a report of a class of transactions that includes the transaction.

In Example 22, the subject matter of Example 21, wherein fields of the template are based on a set of directives received from a third party.

In Example 23, the subject matter of Example 22, wherein the set of directives are regulations promulgated for reporting on the class of transactions.

In Example 24, the subject matter of Example 23, wherein the third party is a government entity.

In Example 25, the subject matter of any of Examples 22-24, wherein fields of the template are serialized for transport.

In Example 26, the subject matter of Example 25, wherein a serialized form of the fields of the template conforms to a JavaScript Object Notation (JSON) family of standards.

In Example 27, the subject matter of any of Examples 21-26, wherein the intake interface includes an application programming interface (API) to receive connections.

In Example 28, the subject matter of Example 27, wherein the API invokes a validation service to verify that the set of data complies with a validation standard or the template.

In Example 29, the subject matter of Example 28, comprising: determining that data in the set of data does not comply with the validation standard; and writing a failure record to a failure field of the template.

In Example 30, the subject matter of Example 29, wherein the data in the set of data that does not comply with the validation standard is written to a third field.

In Example 31, the subject matter of any of Examples 29-30, wherein the data in the set of data that does not comply with the validation standard is discarded.

In Example 32, the subject matter of any of Examples 21-31, wherein the external service provides information on a user that initiated the transaction.

In Example 33, the subject matter of Example 32, wherein the information is demographic or biographic.

In Example 34, the subject matter of any of Examples 21-33, wherein the class of transactions includes at least one of accelerator utilization, memory utilization, storage utilization, or deposited notes.

In Example 35, the subject matter of Example 34, wherein the reporting entity is one of multiple reporting entities that connect to the intake interface for the class of transactions.

In Example 36, the subject matter of Example 35, wherein a first subset of the multiple reporting entities belongs to a first category, a second subset of the multiple reporting entities belongs to a second category, and wherein membership in the first category and the second category is mutually exclusive.

In Example 37, the subject matter of any of Examples 21-36, wherein applying the rules engine to modify the first field of the template or the second field of the template to create the compliant template includes rewriting the first field based on a rule of the rules engine.

In Example 38, the subject matter of any of Examples 21-37, wherein applying the rules engine to modify the first field of the template or the second field of the template to create the compliant template includes swapping a first value in the first field with a second value in the second field.

In Example 39, the subject matter of any of Examples 21-38, comprising providing a user interface configured to: construct a rule for the rules engine; and install the rule in the rules engine to be applied to a next template.

In Example 40, the subject matter of any of Examples 21-39,wherein the external service is a database populated by a batch process from additional external services.

Example 41 is a machine readable medium including instructions for tracking resource ingestion, the instructions, when executed by processing circuitry, cause the processing circuitry to perform operations comprising: receiving a connection from a reporting entity at an intake interface; receiving a set of data over the connection, the set of data including a representation of a resource involved in a transaction; mapping, via the intake interface, the set of data into fields of a template; connecting, based on a first field of the template being set, to an external service to retrieve a value to complete a second field of the template; applying a rules engine to modify the first field of the template or the second field of the template to create a compliant template; and aggregating the compliant template with other compliant templates to produce a report of a class of transactions that includes the transaction.

In Example 42, the subject matter of Example 41, wherein fields of the template are based on a set of directives received from a third party.

In Example 43, the subject matter of Example 42, wherein the set of directives are regulations promulgated for reporting on the class of transactions.

In Example 44, the subject matter of Example 43, wherein the third party is a government entity.

In Example 45, the subject matter of any of Examples 42-44, wherein fields of the template are serialized for transport.

In Example 46, the subject matter of Example 45, wherein a serialized form of the fields of the template conforms to a JavaScript Object Notation (JSON) family of standards.

In Example 47, the subject matter of any of Examples 41-46, wherein the intake interface includes an application programming interface (API) to receive connections.

In Example 48, the subject matter of Example 47, wherein the API invokes a validation service to verify that the set of data complies with a validation standard or the template.

In Example 49, the subject matter of Example 48, wherein the operations comprise: determining that data in the set of data does not comply with the validation standard; and writing a failure record to a failure field of the template.

In Example 50, the subject matter of Example 49, wherein the data in the set of data that does not comply with the validation standard is written to a third field.

In Example 51, the subject matter of any of Examples 49-50,wherein the data in the set of data that does not comply with the validation standard is discarded.

In Example 52, the subject matter of any of Examples 41-51, wherein the external service provides information on a user that initiated the transaction.

In Example 53, the subject matter of Example 52, wherein the information is demographic or biographic.

In Example 54, the subject matter of any of Examples 41-53, wherein the class of transactions includes at least one of accelerator utilization, memory utilization, storage utilization, or deposited notes.

In Example 55, the subject matter of Example 54, wherein the reporting entity is one of multiple reporting entities that connect to the intake interface for the class of transactions.

In Example 56, the subject matter of Example 55, wherein a first subset of the multiple reporting entities belongs to a first category, a second subset of the multiple reporting entities belongs to a second category, and wherein membership in the first category and the second category is mutually exclusive.

In Example 57, the subject matter of any of Examples 41-56, wherein applying the rules engine to modify the first field of the template or the second field of the template to create the compliant template includes rewriting the first field based on a rule of the rules engine.

In Example 58, the subject matter of any of Examples 41-57, wherein applying the rules engine to modify the first field of the template or the second field of the template to create the compliant template includes swapping a first value in the first field with a second value in the second field.

In Example 59, the subject matter of any of Examples 41-58, wherein the operations comprise providing a user interface configured to: construct a rule for the rules engine; and install the rule in the rules engine to be applied to a next template.

In Example 60, the subject matter of any of Examples 41-59, wherein the external service is a database populated by a batch process from additional external services.

Example 61 is a system for tracking resource ingestion, the system comprising: means for receiving a connection from a reporting entity at an intake interface; means for receiving a set of data over the connection, the set of data including a representation of a resource involved in a transaction; means for mapping, via the intake interface, the set of data into fields of a template; means for connecting, based on a first field of the template being set, to an external service to retrieve a value to complete a second field of the template; means for applying a rules engine to modify the first field of the template or the second field of the template to create a compliant template; and means for aggregating the compliant template with other compliant templates to produce a report of a class of transactions that includes the transaction.

In Example 62, the subject matter of Example 61, wherein fields of the template are based on a set of directives received from a third party.

In Example 63, the subject matter of Example 62, wherein the set of directives are regulations promulgated for reporting on the class of transactions.

In Example 64, the subject matter of Example 63, wherein the third party is a government entity.

In Example 65, the subject matter of any of Examples 62-64, wherein fields of the template are serialized for transport.

In Example 66, the subject matter of Example 65, wherein a serialized form of the fields of the template conforms to a JavaScript Object Notation (JSON) family of standards.

In Example 67, the subject matter of any of Examples 61-66, wherein the intake interface includes an application programming interface (API) to receive connections.

In Example 68, the subject matter of Example 67, wherein the API invokes a validation service to verify that the set of data complies with a validation standard or the template.

In Example 69, the subject matter of Example 68, comprising: means for determining that data in the set of data does not comply with the validation standard; and means for writing a failure record to a failure field of the template.

In Example 70, the subject matter of Example 69, wherein the data in the set of data that does not comply with the validation standard is written to a third field.

In Example 71, the subject matter of any of Examples 69-70, wherein the data in the set of data that does not comply with the validation standard is discarded.

In Example 72, the subject matter of any of Examples 61-71, wherein the external service provides information on a user that initiated the transaction.

In Example 73, the subject matter of Example 72, wherein the information is demographic or biographic.

In Example 74, the subject matter of any of Examples 61-73, wherein the class of transactions includes at least one of accelerator utilization, memory utilization, storage utilization, or deposited notes.

In Example 75, the subject matter of Example 74, wherein the reporting entity is one of multiple reporting entities that connect to the intake interface for the class of transactions.

In Example 76, the subject matter of Example 75, wherein a first subset of the multiple reporting entities belongs to a first category, a second subset of the multiple reporting entities belongs to a second category, and wherein membership in the first category and the second category is mutually exclusive.

In Example 77, the subject matter of any of Examples 61-76, wherein the means for applying the rules engine to modify the first field of the template or the second field of the template to create the compliant template include means for rewriting the first field based on a rule of the rules engine.

In Example 78, the subject matter of any of Examples 61-77, wherein the means for applying the rules engine to modify the first field of the template or the second field of the template to create the compliant template include means for swapping a first value in the first field with a second value in the second field.

In Example 79, the subject matter of any of Examples 61-78, comprising means for providing a user interface configured to: construct a rule for the rules engine; and install the rule in the rules engine to be applied to a next template.

In Example 80, the subject matter of any of Examples 61-79, wherein the external service is a database populated by a batch process from additional external services.

Example 81 is at least one machine-readable medium including instructions that, when executed by processing circuitry, cause the processing circuitry to perform operations to implement of any of Examples 1-80.

Example 82 is an apparatus comprising means to implement of any of Examples 1-80.

Example 83 is a system to implement of any of Examples 1- 80.

Example 84 is a method to implement of any of Examples 1-80.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A non-transitory machine readable medium including instructions for tracking resource ingestion, the instructions, when executed by processing circuitry, cause the processing circuitry to perform operations comprising:
receiving a connection from a reporting entity at an intake interface;
receiving a set of data over the connection, the set of data including a representation of a resource involved in a transaction;
mapping, via the intake interface, the set of data into fields of a template;
connecting, based on a first field of the template being set, to an external service to retrieve a value to complete a second field of the template;
applying a rules engine to modify the first field of the template or the second field of the template to create a compliant template; and
aggregating the compliant template with other compliant templates to produce a report of a class of transactions that includes the transaction.

2. The non-transitory machine readable medium of claim 1, wherein fields of the template are based on a set of directives received from a third party.

3. The non-transitory machine readable medium of claim 2, wherein fields of the template are serialized for transport.

4. The non-transitory machine readable medium of claim 3, wherein a serialized form of the fields of the template conforms to a JavaScript Object Notation (JSON) family of standards.

5. The non-transitory machine readable medium of claim 1, wherein the intake interface includes an application programming interface (API) to receive connections.

6. The non-transitory machine readable medium of claim 5, wherein the API invokes a validation service to verify that the set of data complies with a validation standard or the template.

7. The non-transitory machine readable medium of claim 6, wherein the operations comprise:
determining that data in the set of data does not comply with the validation standard; and
writing a failure record to a failure field of the template.

8. The non-transitory machine readable medium of claim 7, wherein the data in the set of data that does not comply with the validation standard is written to a third field.

9. The non-transitory machine readable medium of claim 1, wherein the external service provides information on a user that initiated the transaction.

10. The non-transitory machine readable medium of claim 1, wherein applying the rules engine to modify the first field of the template or the second field of the template to create the compliant template includes rewriting the first field based on a rule of the rules engine.

11. A method for tracking resource ingestion, the method comprising:
receiving a connection from a reporting entity at an intake interface;
receiving a set of data over the connection, the set of data including a representation of a resource involved in a transaction;
mapping, via the intake interface, the set of data into fields of a template;
connecting, based on a first field of the template being set, to an external service to retrieve a value to complete a second field of the template;
applying a rules engine to modify the first field of the template or the second field of the template to create a compliant template; and
aggregating the compliant template with other compliant templates to produce a report of a class of transactions that includes the transaction.

12. The method of claim 11, wherein fields of the template are based on a set of directives received from a third party.

13. The method of claim 12, wherein fields of the template are serialized for transport.

14. The method of claim 13, wherein a serialized form of the fields of the template conforms to a JavaScript Object Notation (JSON) family of standards.

15. The method of claim 11, wherein the intake interface includes an application programming interface (API) to receive connections.

16. The method of claim 15, wherein the API invokes a validation service to verify that the set of data complies with a validation standard or the template.

17. The method of claim 16, comprising:
determining that data in the set of data does not comply with the validation standard; and
writing a failure record to a failure field of the template.

18. The method of claim 17, wherein the data in the set of data that does not comply with the validation standard is written to a third field.

19. The method of claim 11, wherein the external service provides information on a user that initiated the transaction.

20. The method of claim 11, wherein applying the rules engine to modify the first field of the template or the second field of the template to create the compliant template includes rewriting the first field based on a rule of the rules engine.
